(19) United States
(12) Patent Application Publication
(10) Pub. No.: US 2012/0064287 A1
(43) Pub. Date: Mar. 15, 2012

(54) AEROGEL COMPOSITE AND METHOD OF MANUFACTURING THE SAME

(75) Inventors: Sang Ho PARK, Yongin-si (KR); Myung Dong CHO, Hwaseong-si (KR); Kwang Hee KIM, Seoul (KR); Sung Woo HWANG, Yongin-si (KR)

(73) Assignee: SAMSUNG ELECTRONICS CO., LTD., Suwon-si (KR)

(21) Appl. No.: 13/076,122

(22) Filed: Mar. 30, 2011

(30) Foreign Application Priority Data
Sep. 9, 2010 (KR) 10-2010-0088412

(51) Int. Cl. B32B 3/12; B05D 3/00; C08L 61/00

(52) U.S. Cl. 428/117; 521/136; 521/109.1; 521/122; 427/393.5

(57) ABSTRACT

An aerogel composite comprises a support comprising a melamine-formaldehyde copolymer, wherein the support comprises a plurality of micro-openings, and an aerogel matrix disposed in the micro-openings.

### CROSS-REFERENCE TO RELATED APPLICATION

This application claims priority to Korean Patent Application No. 10-2010-0088412, filed on Sep. 9, 2010, and all the benefits accruing therefrom under 35 U.S.C. §119, the content of which in its entirety is herein incorporated by reference.

### BACKGROUND

1. Field

This disclosure relates to an aerogel composite and a method of manufacturing the same.

2. Description of the Related Art

An aerogel is a mesoporous material having a nanometer-sized three-dimensional mesh structure. Aerogels have adiabatic and sound absorption properties, which makes them useful in a variety of diverse areas. In particular, aerogels may be utilized in a cooling device such as a refrigerator and a freezer, used as an adiabatic material in aerospace industry applications, and used in building construction.

Aerogels may be categorized as an inorganic aerogel or an organic aerogel according to the material of the aerogel.

An example of inorganic aerogels is a silica aerogel. An organic aerogel includes an organic linking group therein, and thus is typically more flexible than an inorganic aerogel. However, an organic aerogel may be damaged by an external impact for example, or deformed by shrinkage during drying. There accordingly remains a need in the art for aerogels that can better withstand damage and/or resist deformation during manufacture, including during drying.

### BRIEF SUMMARY OF THE INVENTION

An embodiment of this disclosure provides an aerogel composite with reduced deformation during manufacture and/or improved impact resistance, while still maintaining the properties of an aerogel.

Another embodiment of this disclosure provides a method of manufacturing the aerogel composite.

According to an embodiment, an aerogel composite is provided that includes a support including a polymer network (e.g., melamine-formaldehyde copolymer) and having a plurality of micro-openings, and an aerogel matrix disposed in the micro-openings.

In an embodiment the aerogel matrix may be formed from an organic compound such as an acrylamide-based compound, a benzoxazine-based compound, a bismaleimide-based compound, an aryl alcohol-based compound, a cellulose-based compound, a hydroxyl substituted benzene-aldehyde compound, or an inorganic compound (e.g., silica), or a combination thereof.

The acrylamide-based compound may include at least one of the compounds represented by the following Chemical Formulae 1 to 5.

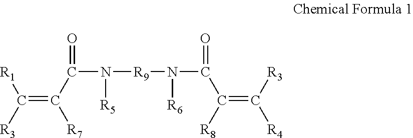

In Chemical Formula 1, R₁ to R₈ are each independently hydrogen, a substituted or unsubstituted C1 to C30 alkyl group, a substituted or unsubstituted C3 to C30 cycloalkyl group, a substituted or unsubstituted C6 to C30 aryl group, a substituted or unsubstituted C7 to C30 arylalkyl group, a substituted or unsubstituted C1 to C30 heteroalkyl group, a substituted or unsubstituted C2 to C30 heterocycloalkyl group, a substituted or unsubstituted C2 to C30 alkenyl group, a substituted or unsubstituted C1 to C10 alkoxy group, a substituted or unsubstituted C2 to C30 carbonyl group, a hydroxyl group, or a combination thereof, and R₉ is a substituted or unsubstituted C1 to C30 alkylene group, a substituted or unsubstituted C3 to C30 cycloalkylene group, a substituted or unsubstituted C6 to C30 arylene group, a substituted or unsubstituted C7 to C30 arylalkylene group, a substituted or unsubstituted C13 to C30 arylenealkylenearylene group, a substituted or unsubstituted C1 to C30 heteroalkylene group, a substituted or unsubstituted C2 to C30 heterocycloalkylene group, a substituted or unsubstituted C2 to C30 alkenylene group, or a combination thereof.

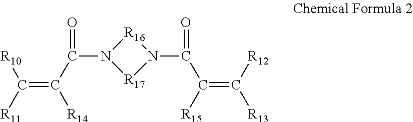

In Chemical Formula 2, R₁₀ to R₁₅ are each independently hydrogen, a substituted or unsubstituted C1 to C30 alkyl group, a substituted or unsubstituted C3 to C30 cycloalkyl group, a substituted or unsubstituted C6 to C30 aryl group, a substituted or unsubstituted C7 to C30 arylalkyl group, a substituted or unsubstituted C1 to C30 heteroalkyl group, a substituted or unsubstituted C2 to C30 heterocycloalkyl group, a substituted or unsubstituted C2 to C30 alkenyl group, a substituted or unsubstituted C1 to C10 alkoxy group, a substituted or unsubstituted C2 to C30 carbonyl group, a hydroxyl group, or a combination thereof, and R₁₆ and R₁₇ are each independently a substituted or unsubstituted C1 to C30 alkylene group, a substituted or unsubstituted C3 to C30 cycloalkylene group, a substituted or unsubstituted C6 to C30 arylene group, a substituted or unsubstituted C7 to C30 arylalkylene group, a substituted or unsubstituted C1 to C30 heteroalkylene group, a substituted or unsubstituted C2 to C30 heterocycloalkylene group, a substituted or unsubstituted C2 to C30 alkenylene group, or a combination thereof.

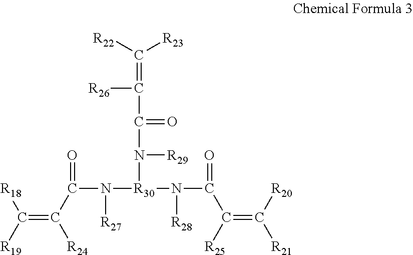

In Chemical Formula 3, R₁₈ to R₂₉ are each independently hydrogen, a substituted or unsubstituted C1 to C30 alkyl group, a substituted or unsubstituted C3 to C30 cycloalkyl group, a substituted or unsubstituted C6 to C30 aryl group, a substituted or unsubstituted C7 to C30 arylalkyl group, a substituted or unsubstituted C1 to C30 heteroalkyl group, a substituted or unsubstituted C2 to C30 heterocycloalkyl group, a substituted or unsubstituted C2 to C30 alkenyl group, a substituted or unsubstituted alkoxy group, a substituted or unsubstituted carbonyl group, a hydroxyl group, or a combination thereof, and R₃₀ is a substituted or unsubstituted C1 to C30 alkylene group, a substituted or unsubstituted C3 to C30 cycloalkylene group, a substituted or unsubstituted C6 to C30 arylene group, a substituted or unsubstituted C7 to C30 arylalkylene group, a substituted or unsubstituted C1 to C30 heteroalkylene group, a substituted or unsubstituted C2 to C30 heterocycloalkylene group, a substituted or unsubstituted C2 to C30 alkenylene group, or a combination thereof.

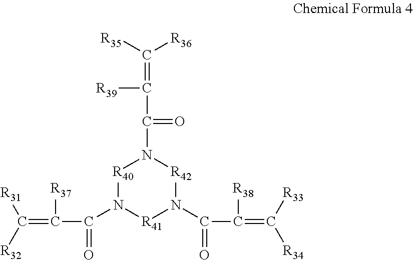

In Chemical Formula 4, R₃₁ to R₃₉ are each independently hydrogen, a substituted or unsubstituted C1 to C30 alkyl group, a substituted or unsubstituted C3 to C30 cycloalkyl group, a substituted or unsubstituted C6 to C30 aryl group, a substituted or unsubstituted C7 to C30 arylalkyl group, a substituted or unsubstituted C1 to C30 heteroalkyl group, a substituted or unsubstituted C2 to C30 heterocycloalkyl group, a substituted or unsubstituted C2 to C30 alkenyl group, a substituted or unsubstituted C1 to C10 alkoxy group, a substituted or unsubstituted C2 to C10 carbonyl group, a hydroxyl group, or a combination thereof, and R₄₀ to R₄₂ are independently a substituted or unsubstituted C1 to C30 alkylene group, a substituted or unsubstituted C3 to C30 cycloalkylene group, a substituted or unsubstituted C6 to C30 arylene group, a substituted or unsubstituted C7 to C30 arylalkylene group, a substituted or unsubstituted C1 to C30 heteroalkylene group, a substituted or unsubstituted C2 to C30 heterocycloalkylene group, a substituted or unsubstituted C2 to C30 alkenylene group, oxygen, sulfur, or a combination thereof.

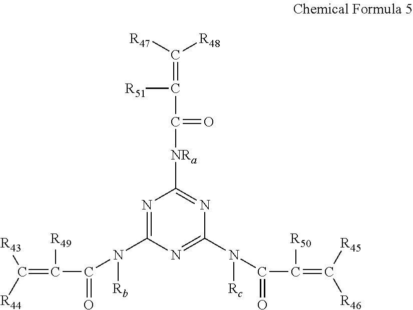

In Chemical Formula 5, R₄₃ to R₅₁ and Ra to Rc are each independently hydrogen, a substituted or unsubstituted C1 to C30 alkyl group, a substituted or unsubstituted C3 to C30 cycloalkyl group, a substituted or unsubstituted C6 to C30 aryl group, a substituted or unsubstituted C7 to C30 arylalkyl group, a substituted or unsubstituted C1 to C30 heteroalkyl group, a substituted or unsubstituted C2 to C30 heterocycloalkyl group, a substituted or unsubstituted C2 to C30 alkenyl group, a substituted or unsubstituted alkoxy group, a substituted or unsubstituted carbonyl group, a hydroxyl group, or a combination thereof.

The acrylamide-based compound may include methylenebisacrylamide, N,N′-hexamethylenebisacrylamide, N,N′-(p-phenylene)bisacrylamide, 4,4′-methylenebis(phenylacrylamide), N,N′-(methylenebis-1,4-phenylene)bis (2-propeneamide), N,N′-(1,4-phenylene)bis(2-methacrylamide), 1,4-bis(acryloyl)piperazine, 1,3,5-triacryloylhexahydro-1,3,5-triazine, or a combination thereof.

The benzoxazine-based compound may include a polymer obtained from an aryl alcohol compound including at least two hydroxyl groups represented by the following Chemical Formula 6 and an amine compound including at least two amine groups represented by the following Chemical Formula 7.

[(HO)ₚ—(CRR′)]ᵣ—(Ar₁)-[L₁-[(Ar₂)—(OH)_{q}]ₙ]ₖ₁ Chemical Formula 6

In Chemical Formula 6, Ar₁ and Ar₂ are each independently a substituted or unsubstituted C6 to C30 aryl group, a substituted or unsubstituted C3 to C30 heteroaryl group, a substituted or unsubstituted C7 to C30 alkylaryl group, or a combination thereof, provided that Ar₂ includes at least one unsubstituted ring carbon (i.e., —CH—) at a position alpha (α) to a hydroxyl group (—OH)

L₁ is a single bond, O, O(═O), S, SO₂, a substituted or unsubstituted C1 to C30 alkylene group, a substituted or unsubstituted C3 to C30 cycloalkylene group, a substituted or unsubstituted C6 to C30 arylene group, a substituted or unsubstituted C7 to C30 alkylarylene group, a substituted or unsubstituted C1 to C30 heteroalkylene group, a substituted or unsubstituted C2 to C30 heterocycloalkylene group, a substituted or unsubstituted C2 to C30 alkenylene group, or a combination thereof,

R and R′ are each independently hydrogen or a substituted or unsubstituted C1 to C10 alkyl group,

r and n are each independently an integer ranging from 0 to 4,

p and q are independently an integer ranging from 1 to 4, and p+q is 3 or more, and

k1 is an integer ranging from 0 to 4, wherein r+k₁ is 1 to 6, and is determined by the valence of Ar₁.

[(NH₂)ₚ—(CRR′)ᵣ₁]ₘZ₁-[L₂-[(Z₂)—[(CR″R′″)ᵣ₂-(NH₂)_{q}]ₙ]ₖ₂ Chemical Formula 7

In Chemical Formula 7, Z₁ and Z₂ are each independently a substituted or unsubstituted C6 to C30 aryl group, a substituted or unsubstituted C3 to C30 heteroaryl group, a substituted or unsubstituted C7 to C30 alkylaryl group, NR (wherein R is hydrogen, an unsubstituted C1 to C20 alkyl group, a C1 to C20 alkyl group substituted with an amino group, an unsubstituted C6 to C30 aryl group or a C6 to C30 aryl group substituted with an amino group, or a combination thereof,

each L₂ is independently a single bond, O, O(═O), S, SO₂, a substituted or unsubstituted C1 to C30 alkylene group, a substituted or unsubstituted C3 to C30 cycloalkylene group, a substituted or unsubstituted C6 to C30 arylene group, a substituted or unsubstituted C7 to C30 alkylarylene group, a substituted or unsubstituted C1 to C30 heteroalkylene group, a substituted or unsubstituted C2 to C30 heterocycloalkylene group, a substituted or unsubstituted C2 to C30 alkenylene group, or a combination comprising at least one of the foregoing groups,

n and m are each independently an integer ranging from 1 to 5,

p and q are each independently an integer ranging from 1 to 4, provided that when k₂ is zero p is at least 2,

R, R′, R″, and R′″ are each independently hydrogen, a C1 to C10 alkyl group or a combination thereof,

r1 and r2 are each independently integers ranging from 0 to 4, and

k2 is an integer ranging from 0 to 4, wherein m+k₂ is selected according to a valence of Z₁.

The bismaleimide-based compound may be represented by the following Chemical Formula 8.

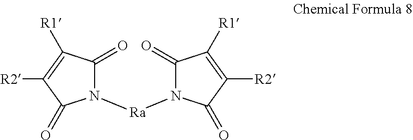

In Chemical Formula 8, R1′ and R2′ are each independently hydrogen, a substituted or unsubstituted C1 to C30 alkyl group or a combination thereof, and Ra is a substituted or unsubstituted C3 to C30 cycloalkylene group, a substituted or unsubstituted C6 to C30 arylene group, a substituted or unsubstituted C13 to C30 arylenealkylenearylene group, a substituted or unsubstituted C27 to C90 (arylenealkylenearylene)ₙ group wherein n is an integer from 2 to 4, a substituted or unsubstituted C2 to C30 heterocycloalkylene group a substituted or unsubstituted C5 to C30 heteroarylene group, a substituted or unsubstituted C12 to C30 arylene(heteroalkylene)arylene group, or a substituted or unsubstituted C26 to C90 (arylene(heteroalkylene)arylene)ₙ group wherein n is an integer from 2 to 4.

The aryl alcohol-based compound may include a polymer of a compound represented by the following Chemical Formula 9.

[(HO)ₚ—(Ar₁)]ₘ-L-[(Ar₂)-(OH)_{q}]ₙ Chemical Formula 9

In Chemical Formula 9,

Ar₁ and Ar₂ are each independently a substituted or unsubstituted C6 to C30 aryl group, a substituted or unsubstituted C3 to C30 heteroaryl group, or a substituted or unsubstituted C7 to C30 alkylaryl group, or a combination comprising at least one of the foregoing groups,

L is a single bond, O, C(═O), S, SO₂, P(═O), P(RR′R″) wherein R, R′, and R″ are each independently hydrogen, a C1 to C10 alkyl group, or a C6 to C20 aryl group, a substituted or unsubstituted C1 to C30 alkylene group, a substituted or unsubstituted C3 to C30 cycloalkylene group, a substituted or unsubstituted C6 to C30 arylene group, a substituted or unsubstituted C7 to C30 arylalkylene group, a substituted or unsubstituted C1 to C30 heteroalkylene group, a substituted or unsubstituted C2 to C30 heterocycloalkylene group, a substituted or unsubstituted C2 to C30 alkenylene group, or a combination thereof,

n and m are each independently an integer ranging from 1 to 5, wherein n+m is determined according to a valance of L, and

p and q are independently integers ranging from 1 to 4.

The cellulose-based compound may include a polymer obtained by cross-linking a substituted or unsubstituted alkyl cellulose derivative represented by the following Chemical Formula 10 with a substituted or unsubstituted diisocyanate compound such as an alkylene diphenylene diisocyanate compound represented by the following Chemical Formula 11.

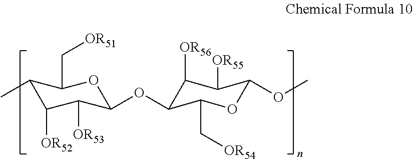

In Chemical Formula 10, R₅₁ to R₅₆ are each independently hydrogen, a C1 to C10 alkyl group, or a combination thereof provided that at least one of R₅₁ to R₅₆ is a C1 to C10 alkyl group, and n is an integer from 10 to 1000.

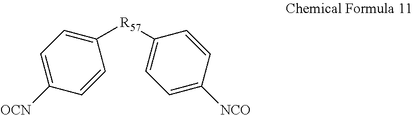

In Chemical Formula 11, R₆₇ is a C1 to C20 alkylene group.

In an embodiment the aerogel matrix may include a resorcinol-formaldehyde copolymer, a resorcinol-formaldehyde-bisphenol A copolymer, or a combination thereof.

In another embodiment the micro-openings may have a size of less than about 300 micrometer (μm).

In another embodiment the support may have a two-dimensional honeycomb or a three-dimensional mesh structure.

In still another embodiment the support may have an expansion ratio or a shrinkage ratio of about 5% or less when being contacted with a solvent.

In an embodiment the aerogel composite may have a density of about 0.015 grams per cubic centimeter (g/cm³) or less.

In another embodiment the aerogel composite may have porosity of about 90% or more.

In still another embodiment the aerogel matrix may include a plurality of pores having a size of about 2 nanometers (nm) to about 50 nm.

According to another embodiment, a manufacturing method for an aerogel composite is provided that includes providing a support comprising a melamine-formaldehyde polymer, wherein the support comprises a plurality of micro-openings, disposing a composition for the formation of an aerogel matrix in the support, and forming the aerogel matrix from the composition in the support to provide the aerogel composite.

The disposing process of a material for producing an aerogel matrix in the support may include preparing an aerogel solution comprising a solvent and an acrylamide-based compound, a benzoxazine-based compound, a bismaleimide-based compound, an aryl alcohol-based compound, a cellulose-based compound, a hydroxyl substituted benzene-aldehyde compound, silica, or precursors thereof, or a combination thereof, disposing the aerogel solution into the plurality of micro-openings of the support, and forming a wet gel from the filled aerogel solution.

The solvent is removed by performing atmospheric pressure drying, supercritical drying, or a combination thereof.

### BRIEF DESCRIPTION OF THE DRAWINGS

The above and other aspects, advantages and features of this disclosure will become more apparent by describing in further detail exemplary embodiments thereof with reference to the accompanying drawings, in which:

FIG. 1 is a schematic diagram of an embodiment of an aerogel composite according to the present invention.

FIGS. 2A, 2B, 2C, and 2D are schematic diagrams sequentially illustrating an embodiment of the manufacturing method of an aerogel composite.

FIGS. 3 and 4 are graphs illustrating nitrogen adsorption-desorption isotherms of an aerogel composite according to Examples 1 and 3, respectively.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

An “alkyl” group is a straight or branched chain saturated aliphatic hydrocarbyl group having the specified number of carbon atoms, a valence of one, and optionally substituted with one or more substituents where indicated.

An “alkenyl” group is a straight or branched chain hydrocarbyl group having the specified number of carbon atoms, a valence of one, at least one carbon-carbon double bond, and optionally substituted with one or more substituents where indicated.

An “alkynyl” group is a straight or branched chain hydrocarbon having the specified number of carbon atoms a valence of one, at least one carbon-carbon triple bond, and optionally substituted with one or more substituents where indicated.

A “cycloalkyl” group is a hydrocarbyl group having one or more saturated rings in which all ring members are carbon, the specified number of carbon atoms, a valence of one, and optionally substituted with one or more substituents where indicated. Non-limiting examples include cyclopropyl, cyclobutyl, cyclopentyl, cyclohexyl, cycloheptyl, cyclooctyl, and adamantly groups. A “cycloalkenyl” group is a cylcoalkyl group having at least one carbon-carbon double bond in the ring, and a “cycloalkynyl” group is a cycloalkyl group having at least one carbon-carbon triple bond in the ring. Cycloalkyl, cycloalkenyl, and cycloalkynyl groups do not contain an aromatic ring or a heterocyclic ring.

An “aryl” group is a carbocyclic ring system that includes one or more aromatic rings in which all ring members are carbon, having the specified number of carbon atoms, a valence of one, and optionally substituted with one or more substituents where indicated and having. More than one ring may be present, and any additional rings may be independently aromatic, saturated, or partially unsaturated and multiple rings, if present, may be fused, pendent, spirocyclic or a combination thereof. Non-limiting examples include phenyl, naphthyl, and tetrahydronaphthyl groups.

An “alkylene” group is an alkyl group having the specified number of carbon atoms, a valence of two or higher, and optionally substituted with one or more substituents where indicated.

An “alkenylene” group is an alkenyl group having the specified number of carbon atoms, a valence of two or higher, and optionally substituted with one or more substituents where indicated.

A “cycloalkylene” group is cycloalkyl group having one or more saturated rings in which all ring members are carbon, the specified number of carbon atoms, a valence of two or higher, and optionally substituted with one or more substituents where indicated.

An “arylene” group is an aryl group having the specified number of carbon atoms, and a valence of two or higher wherein the points of attachment may be on the same or different rings, each of which rings may be aromatic or nonaromatic, and optionally substituted with one or more substituents where indicated. Non-limiting examples include phenylene and naphthylene.

An “arylalkylene” group is an aryl group covalently linked to an alkylene group, having the specified number of carbon atoms, and optionally substituted with one or more substituents where indicated. A non-limiting example is a benzyl group, which is a C7 arylalkylene group.

An “alkylarylene” group is an alkyl group covalently linked to an arylene group, having the specified number of carbon atoms, and optionally substituted with one or more substituents where indicated. A non-limiting example is a 4-methylphenylene group, which is a C7 alkylarylene group.

An “arylalkylenearylene” group is an aryl group linked to an alkylene group that is linked to an arylene group, having the specified number of carbon atoms, and optionally substituted with one or more substituents where indicated. A non-limiting example is a 4-methylphenylene group, which is a C7 alkylarylene group.

As used herein, when a definition is not otherwise provided, the prefix “hetero” means that the group has 1 to 3 heteroatoms independently selected from N, O, S, P, and a combination thereof. In cyclic groups, the 1 to 3 heteroatoms can be present as a ring member. For example, a pyridyl is C5 heteroaryl group, and an “alkoxy” group is a heteroalkyl group where an alkyl moiety is linked via an oxygen (e.g., methoxy).

As used herein, when a definition is not otherwise provided, “substituted” indicates replacement of one or more hydrogen atoms of a group with a substituent selected from a C1 to C30 alkyl group, a C2 to C30 alkenyl group, a C2 to C30 alkynyl group, a C6 to C30 aryl group, a C7 to C30 alkylarylene group, a C1 to C30 heteroalkyl group, a C3 to C30 heteroalkylarylene group, a C3 to C30 cycloalkyl group, a C3 to C15 cycloalkenyl group, a C6 to C30 cycloalkynyl group, a C2 to C30 heterocycloalkyl group, halogen (F, Cl, Br, or I), a hydroxyl group (—OH), an alkoxy group, a nitro group (—NO₂), a cyano group (—CN), an amino group (—NR′₂ wherein each R′ is independently a hydrogen or a C1 to C10 alkyl group, a C2 to C30 alkynyl group, or a C6 to C30 aryl group), an azido group (—N₃), an amidino group, a hydrazine group, a hydrazono group, a carbonyl group (—C(═O)—), a carbamyl group, a thiol group (—SH), an ester group (—C(═O)OR″ wherein R″ is a C1 to C10 alkyl group or a C6 to C10 aryl group), a carboxyl group (—C(═O)OH) or a salt thereof, a sulfonic acid group (—SO₃H₂) or a salt thereof, a phosphoric acid group (—PO₃H₂) or a salt thereof, and a combination thereof.

Hereinafter, an aerogel composite according to an embodiment is illustrated.

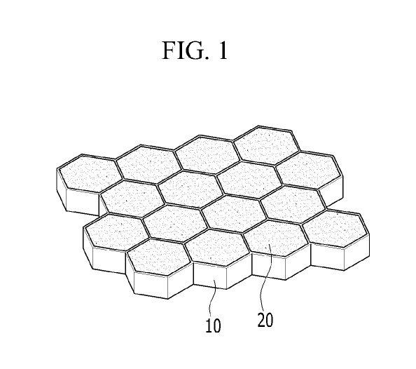

FIG. 1 is a schematic diagram showing an aerogel composite according to an embodiment.

Referring to FIG. 1, according to an embodiment, an aerogel composite includes a support 10, and an aerogel matrix 20 disposed in the support 10.

The support 10 comprises a polymer having a combination of properties suitable for the intended use of the aerogel composite, for example, melt temperature, tensile strength, compressive strength, flexural strength, impact resistance, solvent resistance, heat resistance, hardness, adiabatic properties, and the like, and the polymer can be manufactured to have a plurality of plurality of micro-openings as described below. In an embodiment, the polymer is a melamine-formaldehyde copolymer. The melamine-formaldehyde copolymer has excellent adiabatic properties, as well as excellent mechanical properties making it hard to break down or damage through external impact. Furthermore, the melamine-formaldehyde copolymer has excellent chemical resistance and solvent resistance and does not readily decompose, or highly expand or shrink when contacted by a solvent. In addition, when it is contacted with a solvent, it has an expansion ratio or shrinkage ratio of about 5% or less by volume, specifically 4% or less by volume, more specifically 3% or less by volume, or still more specifically less than 2% or less by volume.

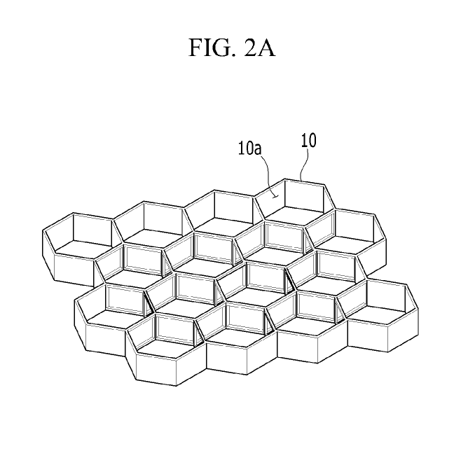

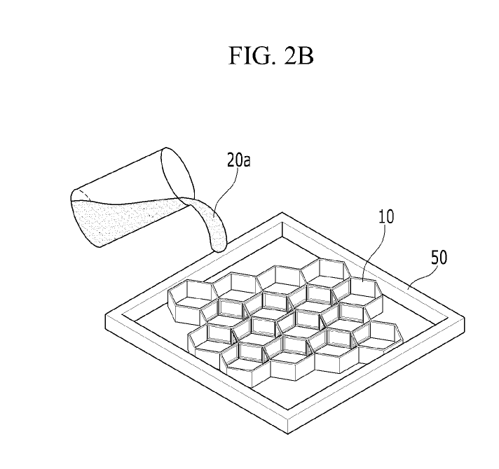

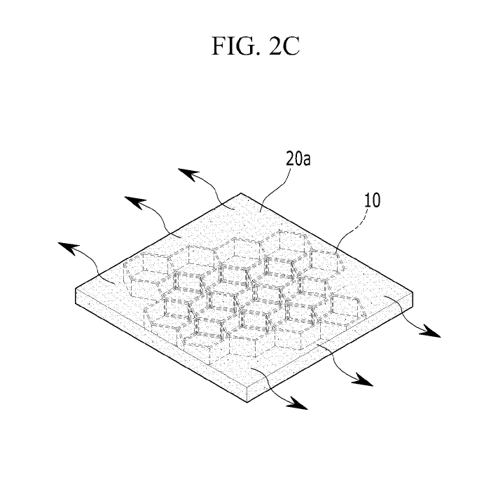

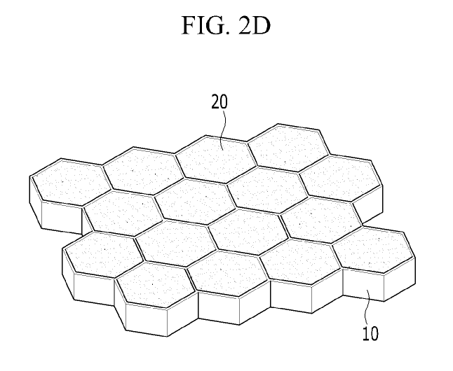

The support 10 has a plurality of micro-openings (micro-open cells) 10a in the interior, as illustrated in FIG. 2A. Each of the micro-openings 10a may have a fine size wherein the average largest diameter of the micro-opening is about 300 micrometers (μm) or less, and may have a variety of irregular or regular shapes such as a circle, an oval, an ellipse, a polygon, a sphere, and the like. The shape of the micro-openings may be the same or different within a support.

A plurality of micro-openings 10a, as illustrated in FIG. 2A, may have a two-dimensional honeycomb or a three-dimensional mesh structure. The micro-openings need not be uniformly distributed, i.e., there may be areas in the support containing a lower or higher concentration or number of micro-openings. In an embodiment, the micro-openings are evenly distributed throughout the support. Adjacent micro-openings 10a may be open to each other, for example forming a continuous network of pores. In an embodiment the support may have a porosity of about 50% or more, about 70% or more, about 90% or more, or about 95% or more. The support may have a porosity of 99.9% or less.

Each of the micro-openings 10a contains an aerogel matrix 20. In an embodiment, each of the micro-openings is filled with an aerogel matrix 20.

The aerogel matrix 20 may include mesopores having a size ranging from about 2 nanometers (nm) to about 50 nm and a porosity ranging from about 80% to about 99.9% by volume, based on the total volume of the aerogel matrix 20. In another embodiment, the aerogel matrix 20 may have a porosity ranging from about 90% to about 99.9%.

The aerogel matrix 20 may comprise an organic, an inorganic, or an organic/inorganic aerogel.

In one exemplary embodiment, the aerogel matrix 20 may be formed from an acrylamide-based compound, a benzoxazine-based compound, a bismaleimide-based compound, an aryl alcohol-based compound, a cellulose-based compound, a hydroxyl substituted benzene-aldehyde compound, silica, or a combination thereof. It is to be understood that during the process of manufacturing the aerogel, these compounds may be transformed (e.g., polymerized or crosslinked) or substantially unchanged in the final aerogel composite material.

The acrylamide-based compound may include, for example, a bisacrylamide-based compound having two substituted or unsubstituted acrylamide groups, a trisacrylamide-based compound having three substituted or unsubstituted acrylamide groups, or a tetraacrylamide-based compound having four or more substituted or unsubstituted acrylamide groups.

The acrylamide-based compound may include at least one of the compounds represented by the following Chemical Formulae 1 to 5.

The compound of the following Chemical Formula 1 is an example of a bisacrylamide-based compound.

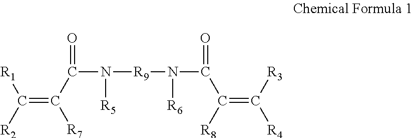

In Chemical Formula 1, R₁ to R₈ are each independently hydrogen, a substituted or unsubstituted C1 to C30 alkyl group, a substituted or unsubstituted C3 to C30 cycloalkyl group, a substituted or unsubstituted C6 to C30 aryl group, a substituted or unsubstituted C7 to C30 arylalkyl group, a substituted or unsubstituted C1 to C30 heteroalkyl group, a substituted or unsubstituted C2 to C30 heterocycloalkyl group, a substituted or unsubstituted C2 to C30 alkenyl group, a substituted or unsubstituted C1 to C10 alkoxy group, a substituted or unsubstituted C2 to C30 carbonyl group, a hydroxyl group, or a combination thereof, and R₉ is a substituted or unsubstituted C1 to C30 alkylene group, a substituted or unsubstituted C3 to C30 cycloalkylene group, a substituted or unsubstituted C6 to C30 arylene group, a substituted or unsubstituted C7 to C30 arylalkylene group, a substituted or unsubstituted C13 to C30 arylalkylenearylene group, a substituted or unsubstituted C1 to C30 heteroalkylene group, a substituted or unsubstituted C2 to C30 heterocycloalkylene group, a substituted or unsubstituted C2 to C30 alkenylene group, or a combination thereof. In an embodiment, R₇ and R₈ are hydrogen, methyl, or a combination thereof.

The compound of Chemical Formula 1 may include, for example methylenebisacrylamide, N,N′-hexamethylenebisacrylamide, N,N′-(p-phenylene)bisacrylamide, N,N′-(methylenebis-1,4-phenylene)bis(2-propeneamide), N,N′-(1,4-phenylene)bis(2-methacrylamide) and the like.

Each of methylenebisacrylamide, N,N′-hexamethylenebisacrylamide, N,N′-(p-phenylene)bisacrylamide, N,N′-(methylenebis-1,4-phenylene)bis(2-propeneamide), and N,N′-(1,4-phenylene)bis(2-methacrylamide) may be represented by the following Chemical Formulae 1a to 1e, respectively.

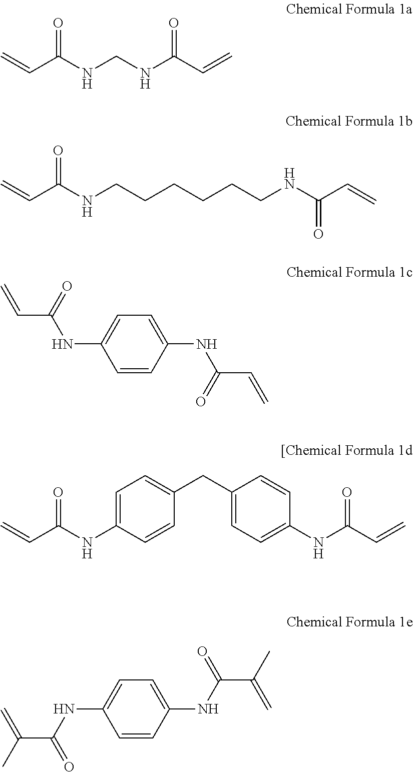

The compound of the following Chemical Formula 2 is also an example of the bisacrylamide-based compound.

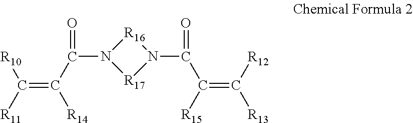

In Chemical Formula 2, R₁₀ to R₁₅ are each independently hydrogen, a substituted or unsubstituted C1 to C30 alkyl group, a substituted or unsubstituted C3 to C30 cycloalkyl group, a substituted or unsubstituted C6 to C30 aryl group, a substituted or unsubstituted C7 to C30 arylalkyl group, a substituted or unsubstituted C1 to C30 heteroalkyl group, a substituted or unsubstituted C2 to C30 heterocycloalkyl group, a substituted or unsubstituted C2 to C30 alkenyl group, a substituted or unsubstituted C1 to C10 alkoxy group, a substituted or unsubstituted C2 to C30 carbonyl group, a hydroxyl group, or a combination thereof, and R₁₆ and R₁₇ are each independently a substituted or unsubstituted C1 to C30 alkylene group, a substituted or unsubstituted C3 to C30 cycloalkylene group, a substituted or unsubstituted C6 to C30 arylene group, a substituted or unsubstituted C7 to C30 arylalkylene group, a substituted or unsubstituted C1 to C30 heteroalkylene group, a substituted or unsubstituted C2 to C30 heterocycloalkylene group, a substituted or unsubstituted C2 to C30 alkenylene group, or a combination thereof. In an embodiment, R₁₄ and R₁₅ are hydrogen, methyl, or a combination thereof.

The compound of Chemical Formula 2 may include, for example, 1,4-bis(acryloyl)piperazine represented by the following Chemical Formula 2a.

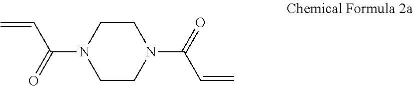

The compound of the following Chemical Formula 3 is an example of the trisacrylamide-based compound.

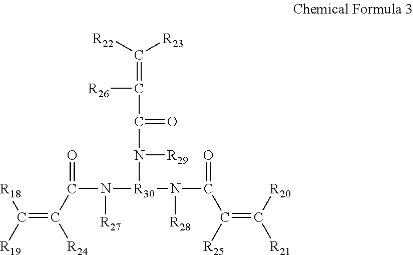

In Chemical Formula 3, R₁₈ to R₂₉ are each independently hydrogen, a substituted or unsubstituted C1 to C30 alkyl group, a substituted or unsubstituted C3 to C30 cycloalkyl group, a substituted or unsubstituted C6 to C30 aryl group, a substituted or unsubstituted C7 to C30 arylalkyl group, a substituted or unsubstituted C1 to C30 heteroalkyl group, a substituted or unsubstituted C2 to C30 heterocycloalkyl group, a substituted or unsubstituted C2 to C30 alkenyl group, a substituted or unsubstituted alkoxy group, a substituted or unsubstituted carbonyl group, a hydroxyl group, or a combination thereof, and R₃₀ is a substituted or unsubstituted C1 to C30 alkylene group, a substituted or unsubstituted C3 to C30 cycloalkylene group, a substituted or unsubstituted C6 to C30 arylene group, a substituted or unsubstituted C7 to C30 arylalkylene group, a substituted or unsubstituted C1 to C30 heteroalkylene group, a substituted or unsubstituted C2 to C30 heterocycloalkylene group, a substituted or unsubstituted C2 to C30 alkenylene group, or a combination thereof. In an embodiment, R₂₄, R₂₅, and R₂₆ are hydrogen, methyl, or a combination thereof. In Chemical Formula 3, R₃₀ may include a compound represented by the following Chemical Formulae 3a and 3b.

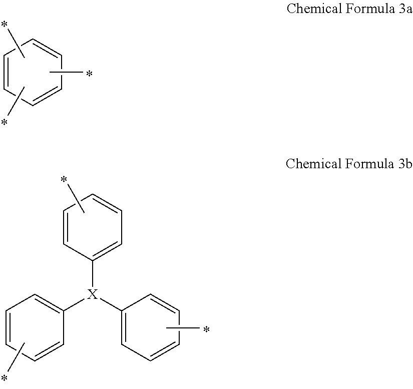

In Chemical Formula 3b, X is selected from CH, Si, or N and in both Chemical Formulae 3a and 3b, “*” represents the point of attachment of R₃₀ to —N—R₂₇, —N—R₂₈, and —N—R₂₉, respectively. In a specific embodiment, R₃₀ may be selected from

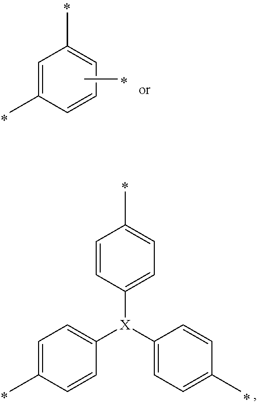

wherein X is selected from CH, Si, and N and “*” represents the point of attachment of R₃₀ to —N—R₂₇, —N—R₂₈, and —N—R₂₉, respectively.

The compound of the following Chemical Formula 4 is also an example of the trisacrylamide-based compound.

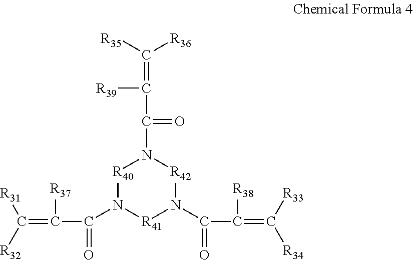

In Chemical Formula 4, R₃₁ to R₃₉ are each independently hydrogen, a substituted or unsubstituted C1 to C30 alkyl group, a substituted or unsubstituted C3 to C30 cycloalkyl group, a substituted or unsubstituted C6 to C30 aryl group, a substituted or unsubstituted C7 to C30 arylalkyl group, a substituted or unsubstituted C1 to C30 heteroalkyl group, a substituted or unsubstituted C2 to C30 heterocycloalkyl group, a substituted or unsubstituted C2 to C30 alkenyl group, a substituted or unsubstituted C1 to C10 alkoxy group, a substituted or unsubstituted C2 to C10 carbonyl group, a hydroxyl group, or a combination thereof, and R₄₀ to R₄₂ are each independently a substituted or unsubstituted C1 to C30 alkylene group, a substituted or unsubstituted C3 to C30 cycloalkylene group, a substituted or unsubstituted C6 to C30 arylene group, a substituted or unsubstituted C7 to C30 arylalkylene group, a substituted or unsubstituted C1 to C30 heteroalkylene group, a substituted or unsubstituted C2 to C30 heterocycloalkylene group, a substituted or unsubstituted C2 to C30 alkenylene group, oxygen, sulfur, or a combination thereof. In an embodiment, R₃₇, R₃₈, and R₃₉ are hydrogen, methyl, or a combination thereof.

The compound of Chemical Formula 4 may include, for example, 1,3,5-triacryloylhexahydro-1,3,5-triazine represented by the following Chemical Formula 4a.

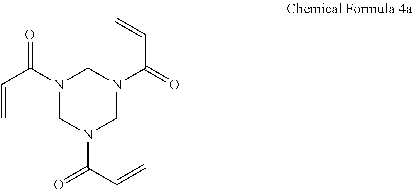

The compound of the following Chemical Formula 5 is also an example of the trisacrylamide-based compound.

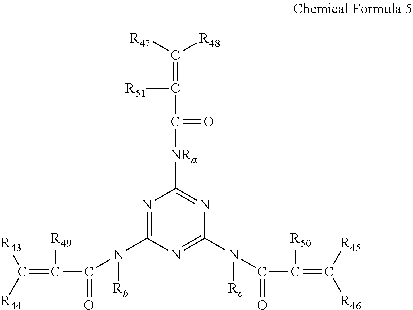

In Chemical Formula 5, R₄₃ to R₅₁ and Ra to Rc are each independently hydrogen, a substituted or unsubstituted C1 to C30 alkyl group, a substituted or unsubstituted C3 to C30 cycloalkyl group, a substituted or unsubstituted C6 to C30 aryl group, a substituted or unsubstituted C7 to C30 arylalkyl group, a substituted or unsubstituted C1 to C30 heteroalkyl group, a substituted or unsubstituted C2 to C30 heterocycloalkyl group, a substituted or unsubstituted C2 to C30 alkenyl group, a substituted or unsubstituted alkoxy group, a substituted or unsubstituted carbonyl group, a hydroxyl group, or a combination thereof.

The benzoxazine-based compound may include a polymer obtained by polymerization of an aryl alcohol compound including at least two hydroxyl groups and an amine compound including at least two amine groups.

The aryl alcohol compound comprising at least two hydroxyl groups may be represented by the following Chemical Formula 6.

[(HO)ₚ—(CRR′)]ᵣ—(Ar₁)-[L₁-[(Ar₂)—(OH)_{q}]ₙ]ₖ₁ Chemical Formula 6

In Chemical Formula 6, Ar₁ and Ar₂ are each independently a substituted or unsubstituted C6 to C30 arylene group, a substituted or unsubstituted C3 to C30 heteroarylene group, a substituted or unsubstituted C7 to C30 alkylarylene group, or a combination thereof, provided that Ar₂ includes at least one unsubstituted ring carbon (i.e., —CH—) at a position alpha (α) to a hydroxyl group (—OH),

L₁ is a single bond, O, C(═O), S, SO₂, a substituted or unsubstituted C1 to C30 alkylene group, a substituted or unsubstituted C3 to C30 cycloalkylene group, a substituted or unsubstituted C6 to C30 arylene group, a substituted or unsubstituted C7 to C30 alkylarylene group, a substituted or unsubstituted C1 to C30 heteroalkylene group, a substituted or unsubstituted C2 to C30 heterocycloalkylene group, a substituted or unsubstituted C2 to C30 alkenylene group, or a combination thereof,

R and R′ are each independently hydrogen or a substituted or unsubstituted C1 to C10 alkyl group,

r and n are each independently an integer ranging from 0 to 4,

p and q are independently an integer ranging from 1 to 4, and p+q is 3 or more, and

k1 is an integer ranging from 0 to 4, wherein r+k₁ is 1 to 6, and is determined by the valence of Ar₁.

The compound of Chemical Formula 6 may be, for example the compound of the following Chemical Formula 6a.

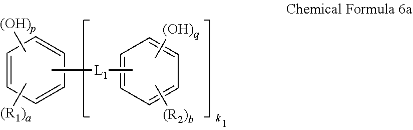

In Chemical Formula 6a,

each L₁ is a single bond, O, C(═O), S, SO₂, a substituted or unsubstituted C1 to C30 alkylene group, a substituted or unsubstituted C3 to C30 cycloalkylene group, a substituted or unsubstituted C6 to C30 arylene group, a substituted or unsubstituted C7 to C30 alkylarylene group, a substituted or unsubstituted C1 to C30 heteroalkylene group, a substituted or unsubstituted C2 to C30 heterocycloalkylene group, a substituted or unsubstituted C2 to C30 alkenylene group, or a combination thereof,

R₁ and R₂ are each independently selected from hydrogen, a hydroxyl group, a substituted or unsubstituted C1 to C10 alkyl group, a substituted or unsubstituted C1 to C10 alkoxy group, NRR′, OR, NH(C═O)R, OC(═O)R, a substituted or unsubstituted C6 to C18 aryl group, CH═CR, or a combination comprising at least one of the foregoing groups, wherein the R and R′ are each independently hydrogen or a substituted or unsubstituted C1 to C10 alkyl group,

p and q are each independently an integer ranging from 1 to 4, p+q is 2 or more provided that, and when k1 is 0, p is 2, 3 or 4,

a and b are each independently an integer ranging from 1 to 3, and

k1 is an integer ranging from 0 to 4, provided that a benzene ring of Chemical Formula 4B includes at least one unsubstituted ring carbon (i.e., a —CH— at the alpha (α) position to a hydroxyl group (OH).

In an embodiment of the above Chemical Formula 6a, at least one of R₁ and R₂ is a substituted or unsubstituted C1 to C10 alkyl group, a substituted or unsubstituted C1 to C10 alkoxy group, NRR′, OR, NH(CO)R, OC(═O)R, a substituted or unsubstituted C6 to C18 aryl group, CH═CR, or a combination thereof, wherein R and R′ are each independently hydrogen or a substituted or unsubstituted C1 to C10 alkyl group.

L₁ may be a linker represented by the following Chemical Formula 6b.

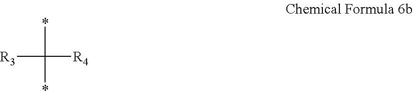

In Chemical Formula 6b, R₃, and R₄ are each independently a substituted or unsubstituted C1 to C10 alkyl group, a substituted or unsubstituted C1 to C10 alkoxy group, a substituted or unsubstituted C3 to C20 cycloalkyl group, or a substituted or unsubstituted C6 to C18 aryl group. The alkyl group, cycloalkyl group, and aryl groups may be substituted with a hydroxyl group. In the above Chemical Formula 6b, “*” represent the point of attachment of L₁ to Ar₁ and Ar₂, respectively.

The amine compound including at least two amine groups may be represented by the following Chemical Formula 7.

[(NH₂)ₚ—(CRR′)ᵣ₁]ₘZ₁-[L₂-[(Z₂)—[(CR″R′″)ᵣ₂—(NH₂)_{q}]ₙ]ₖ₂ Chemical Formula 7

In Chemical Formula 7, Z₁ and Z₂ are each independently a substituted or unsubstituted C6 to C30 arylene group, a substituted or unsubstituted C3 to C30 heteroarylene group, a substituted or unsubstituted C7 to C30 alkylarylene group, NR (wherein R is hydrogen, an unsubstituted C1 to C20 alkyl group, a C1 to C20 alkyl group substituted with an amino group, an unsubstituted C6 to C30 aryl group, or a C6 to C30 aryl group substituted with an amino group), or a combination thereof,

each L₂ is independently a single bond, O, C(═O), S, SO₂, a substituted or unsubstituted C1 to C30 alkylene group, a substituted or unsubstituted C3 to C30 cycloalkylene group, a substituted or unsubstituted C6 to C30 arylene group, a substituted or unsubstituted C7 to C30 alkylarylene group, a substituted or unsubstituted C1 to C30 heteroalkylene group, a substituted or unsubstituted C2 to C30 heterocycloalkylene group, a substituted or unsubstituted C2 to C30 alkenylene group, or a combination thereof,

n and m are each independently an integer ranging from 1 to 5,

p and q are each independently an integer ranging from 1 to 4, provided that when k₂ is zero p is at least 2,

R, R′, R″, and R′″ are each independently hydrogen, a C1 to C10 alkyl group, or a combination thereof,

r1 and r2 are each independently an integer ranging from 0 to 4, and

k2 is an integer ranging from 0 to 4, wherein m+k₂ is selected according to a valence of Z₁.

The amine compound comprising at least two amine groups may be used in an amount ranging from about 1 mole to about 1.5 moles, specifically about 1.1 to about 1.4 moles, more specifically about 1.2 to about 1.3 moles, based on 1 mole of the aryl alcohol compound comprising at least two hydroxy groups.

The bismaleimide-based compound may be a compound represented by the following Chemical Formula 8.

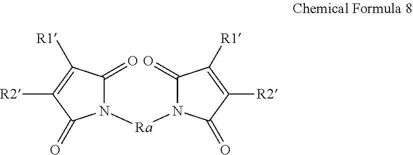

In Chemical Formula 8, R1′ and R2′ are each independently hydrogen, a substituted or unsubstituted C1 to C30 alkyl group, or a combination thereof, and Ra is a substituted or unsubstituted C3 to C30 cycloalkylene group, a substituted or unsubstituted C6 to C30 arylene group, a substituted or unsubstituted C13 to C30 arylenealkylenearylene group, a substituted or unsubstituted C27 to C90 (arylenealkylenearylene)ₙ group wherein n is an integer from 2 to 4, a substituted or unsubstituted C2 to C30 heterocycloalkylene group, a substituted or unsubstituted C3 to C30 heteroarylene group, a substituted or unsubstituted C12 to C30 arylene(heteroalkylene)arylene group, a substituted or unsubstituted C26 to C90 (arylene(heteroalkylene)arylene)ₙ group wherein n is an integer from 2 to 4, or a combination thereof.

The bismaleimide compound may be represented by the following Chemical Formulae 8a to 8c.

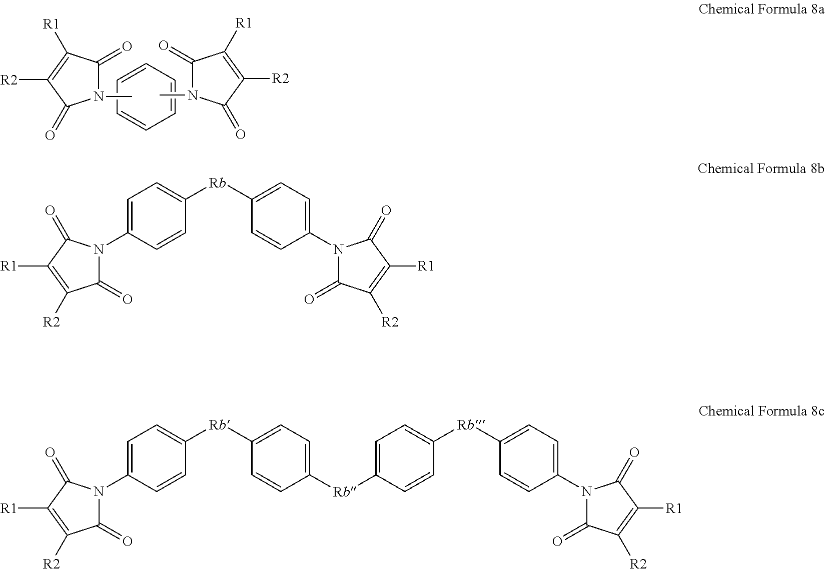

In Chemical Formulae 8a to 8c, R1 and R2 are each independently hydrogen, a substituted or unsubstituted C1 to C30 alkyl group, or a combination thereof, and Rb, Rb′, Rb″, and R′″ are each independently a C1 to C10 alkylene group, a C1 to C10 heteroalkylene group, O, S, or a combination thereof.

The bismaleimide compound may form a polymer by reaction with a compound having at least two double bonds, for example vinyl groups, reactive with the bismaleimide compound. The compound having at least two double bonds may include a substituted or unsubstituted C6 to C30 aromatic compound having at least two vinyl groups, a substituted or unsubstituted C4 to C20 acrylate compound, a substituted or unsubstituted C4 to C20 acrylamide compound, or a combination thereof.

The aryl alcohol compound may include a polymer of a compound represented by the following Chemical Formula 9.

[(HO)ₚ—(Ar₁)]ₘ-L-[(Ar₂)-(OH)_{q}]ₙ Chemical Formula 9

In Chemical Formula 9,

Ar₁ and Ar₂ are each independently a substituted or unsubstituted C6 to C30 aryl group, a substituted or unsubstituted C3 to C30 heteroaryl group, a substituted or unsubstituted C7 to C30 alkylaryl group, or a combination thereof,

L is a single bond, O, C(═O), S, SO₂, P(═O), P(RR′R″) (wherein R, R′, and R″ are each independently hydrogen, a C1 to C10 alkyl group, a C6 to C20 aryl group, or a combination thereof), a substituted or unsubstituted C1 to C30 alkylene group, a substituted or unsubstituted C3 to C30 cycloalkylene group, a substituted or unsubstituted C6 to C30 arylene group, a substituted or unsubstituted C7 to C30 arylalkylene group, a substituted or unsubstituted C12 to C18 arylalkylenearylenealkylene group, a substituted or unsubstituted C1 to C30 heteroalkylene group, a substituted or unsubstituted C2 to C30 heterocycloalkylene group, a substituted or unsubstituted C2 to C30 alkenylene group, or a combination thereof,

n and m are each independently an integer ranging from 1 to 5, wherein n+m is determined according to a valance of L, and

p and q are independently integers ranging from 1 to 4.

The cellulose-based compound may include an alkyl cellulose-based compound.

The alkyl cellulose-based compound may include a polymer obtained by cross-linking a substituted or unsubstituted alkyl cellulose derivative (hereinafter referred to as “alkyl cellulose derivative”) and a substituted or unsubstituted diisocyanate compound, for example a substituted or unsubstituted alkylene diphenylene diisocyanate compound (hereinafter referred to as “alkylene diphenylene diisocyanate compound”).

The alkyl cellulose derivative may be a compound represented by the following Chemical Formula 10.

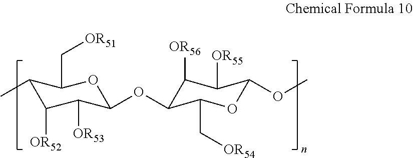

In Chemical Formula 10, R₅₁ to R₅₆ are each independently hydrogen, a C1 to C10 alkyl group, or a combination thereof provided that at least one of R₅₁ to R₅₆ is a C1 to C10 alkyl group, and n is 10 to 1000.

The alkyl cellulose derivative may have a molecular weight of about 10,000 Daltons to about 300,000 Daltons, or about 10,000 Daltons to about 50,000 Daltons. Herein, each repeating unit has a molecular weight of about 450 grams.

The alkyl cellulose derivative may include ethyl cellulose where at least one of R₅₁ to R₅₆ is an ethyl group.

The alkylene diphenylene diisocyanate compound may be a compound represented by the following Chemical Formula 11.

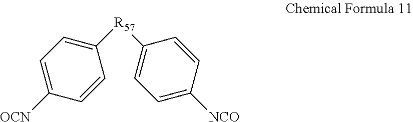

In Chemical Formula 11, R₅₇ is a C1 to C20 alkylene group.

The alkylene diphenylene diisocyanate includes methylene diphenylene diisocyanate represented by the following Chemical Formula 11a.

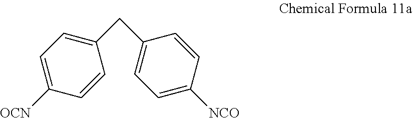

The aerogel matrix may include a hydroxyl substituted benzene-aldehyde compound.

The hydroxyl substituted benzene-aldehyde compound may be represented by the following Chemical Formula 12

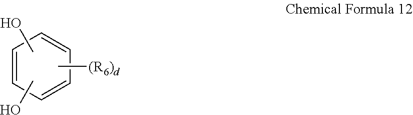

In Chemical Formula 12,

each R₆ is independently a hydroxyl group, a substituted or unsubstituted C1 to C10 alkyl group, a substituted or unsubstituted C1 to C10 alkoxy group, —NRR′, —OR, —NH(C(O))R, —OC(O)R, a substituted or unsubstituted C6 to C18 aryl group, or —CH═CR, or a combination thereof, wherein R and are each independently hydrogen, or a substituted or unsubstituted C1 to C10 alkyl group, and d is an integer of 1 or 2.

Examples of the hydroxyl substituted benzene compound include resorcinol, hydroquinone, catechol, phloroglucinol, or a combination thereof.

Examples of the aldehyde compound include formaldehyde, furfural, paraformaldehyde, trioxymethylene, acetaldehyde, butyraldehyde, acrolein, furylacrolein, crotonaldehyde, glyoxal, benzaldehyde, or a combination thereof.

Examples of the hydroxyl substituted benzene-aldehyde compound include resorcinol formaldehyde-based compound, a resorcinol formaldehyde bisphenol-based compound, and a combination thereof. In an embodiment, the aerogel matrix may include for example a resorcinol-formaldehyde copolymer, a resorcinol-formaldehyde-bisphenol A copolymer.

In an embodiment, the aerogel matrix may include an inorganic material such as silica.

The aerogel composite may have density of about 0.015 g/cm³ or less, and in an embodiment, it may have density ranging from about 0.010 g/cm³ to about 0.015 g/cm³.

In certain exemplary embodiments, the aerogel composite may have porosity of about 70% or more, 80% or more, 90% or more, or 95% or more by volume. The aerogel composite may further have a porosity of 99.9% or less by volume.

A method of producing an aerogel composite generally includes providing a support comprising a melamine-formaldehyde copolymer, wherein the support comprises a plurality of micro-openings; disposing a composition for producing an aerogel matrix in the support; and forming the aerogel matrix from the composition disposed in the support to provide the aerogel composite. As stated above, the compositions for forming the aerogel matrix may containing precursors (e.g., monomer units) or the matrix material itself. Hereinafter, referring to FIG. 2, an embodiment of a method of preparing the aerogel composite is described.

FIGS. 2A to 2D are schematic diagrams sequentially showing the method of preparing the aerogel composite according to one embodiment.

Referring to FIGS. 2A to 2D, the method of preparing the aerogel composite according to an embodiment may include (a) providing a polymer support 10, as shown in FIG. 2A, that includes a plurality of micro-openings 10a, wherein the polymer support 10 may comprise a melamine-formaldehyde copolymer, (b) disposing, e.g., filling or impregnating a composition for producing the aerogel matrix, e.g., an aerogel solution for producing an aerogel matrix 20a into the support 10, as shown in FIG. 2B, (c) removing the solvent from the support 10 filled with the aerogel solution for producing the aerogel matrix 20a, as shown in FIG. 2C, to produce the aerogel-matrix composite as shown in FIG. 2D.

In particular, the support 10 is provided, e.g., prepared, and may have a plurality of micro-openings 10a that have a size of about 300 μm or less and may be made of a melamine-formaldehyde copolymer.

Next, the support 10 may be placed into a vessel, e.g., a tank 50, as shown in FIG. 2B, having a predetermined size. Then the micro-openings 10a of the support 10 are impregnated or otherwise contacted with the aerogel solution for producing an aerogel matrix 20a, as shown in FIG. 2B. The aerogel solution for an aerogel matrix 20a may include a solvent and an acrylamide-based compound, a benzoxazine-based compound, a bismaleimide-based compound, an aryl alcohol-based compound, a cellulose-based compound, a resorcinol formaldehyde-based compound, a bisphenol-based compound, silica, or precursors thereof, or combinations thereof. An optional catalyst may be present in the aerogel solution.

Next, the solution for an aerogel matrix is gelated, that is, a wet-gel is formed.

The solvent is then removed from the support 10, as shown in FIG. 2C. The solvent removal process may be performed by atmospheric pressure drying, supercritical drying, or a combination thereof. The supercritical drying may use carbon dioxide.

Next, an aerogel composite including an aerogel matrix 20 disposed in micro-openings 10a of the support 10 is prepared by separating the support 10 from the tank 50, as shown in FIG. 2D.

Hereinafter, this disclosure is illustrated in more detail with reference to non-limiting examples. However, they are exemplary embodiments of this disclosure and are not limiting.

### Preparation of an Aerogel Composite

### Example 1

650 mL of acetonitrile is added to a 1250 mL polypropylene box, and 50 g of resorcinol, 40 mL of hydrochloride (“HCl”) (0.6 Molar acetonitrile solution) and 75 mL of formalin (37 wt % aqueous solution) are added thereto and dissolved. The mixture is vigorously agitated to prepare a composition for an aerogel.

The composition for an aerogel is impregnated in a support (Basotect UF, manufactured by BASF) that is made of a melamine-formaldehyde copolymer.

Next, the reaction temperature is slowly increased to 60° C. over 10 minutes, and a gel is identified by checking fluidity at the interface. Next, the prepared gel is matured at room temperature of about 25° C. or under an increasing temperature, to provide a wet-gel.

The prepared wet-gel is exchanged with acetone, a solvent having good compatibility with liquid carbon dioxide. Then, the liquid carbon dioxide is provided to a high pressure reactor to remove the acetone inside the wet gel. When the acetone inside the wet gel is removed, an aerogel composite is prepared by increasing its temperature and pressure beyond the threshold temperature of carbon dioxide and then slowly taking away the carbon dioxide at the same temperature to reduce the pressure.

### Example 2

An aerogel composite is prepared according to the same method as Example 1, except that 25 g of resorcinol and 25 g of bisphenol A in addition to the 75 mL of formalin are used for preparing a composition for an aerogel.

### Example 3

500 mL of dimethyl formamide (“DMF”) is added to a 1250 mL polypropylene box, and 50 g of 1,3,5-triacryloylhexahydro-1,3,5-triazine, 2.5 mL of ammonium persulfate (1.0 Molar aqueous solution) as a initiator, and 2.5 mL of N,N,N′,N′-tetramethylethylene diamine as a catalyst are added therein, then the mixture is vigorously agitated to prepare a composition for an aerogel.

The composition for an aerogel is impregnated in a support that is made of a melamine-formaldehyde copolymer.

Next, the reaction temperature is slowly increased to 60° C. over 10 minutes, and a gel is identified by checking fluidity on the interface. Next, the prepared gel is matured at room temperature of about 25° C. or under an increasing temperature, preparing a wet gel.

The prepared wet gel is exchanged with acetone, a solvent having good compatibility with liquid carbon dioxide. Then, the liquid carbon dioxide is provided to a high pressure reactor to remove the acetone inside the wet gel. When the acetone inside the wet gel is removed, an aerogel composite is prepared by increasing its temperature and pressure beyond the threshold temperature of carbon dioxide and then slowly taking away the carbon dioxide at the same temperature to reduce the pressure.

### Example 4

An aerogel composite is prepared according to the same method as Example 3, except that 1,3,5-triacryloylhexahydro-1,3,5-triazine and methylenebisacrylamide are used at a mole ratio of 2:3 instead of 1,3,5-triacryloylhexahydro-1,3,5-triazine.

### Comparative Example 1

An aerogel is prepared by forming a wet gel that is formed by a composition for an aerogel according to Example 1 and drying without using a support.

### Comparative Example 2

An aerogel composite is prepared according to the same method as Example 1, except that a polyurethane-based open foam is used as a support, instead of the support made of a melamine-formaldehyde copolymer.

### Comparative Example 3

An aerogel composite is prepared according to the same method as Example 1, except that a polyester-based open foam is used as a support, instead of the support made of a melamine-formaldehyde copolymer.

Evaluation 1

Nitrogen (“N₂”) adsorption-desorption characteristics of an aerogel composite according to Examples 1 and 3 are identified.

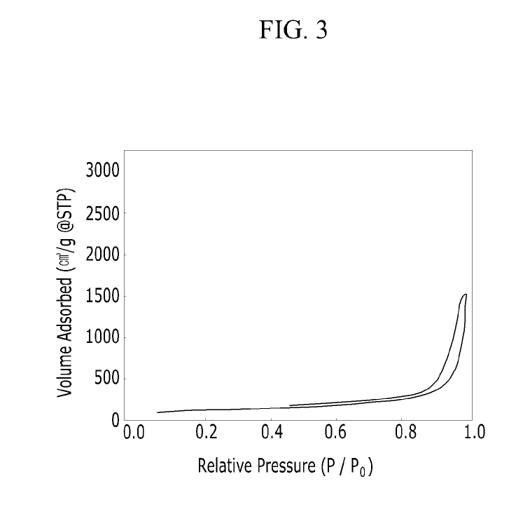

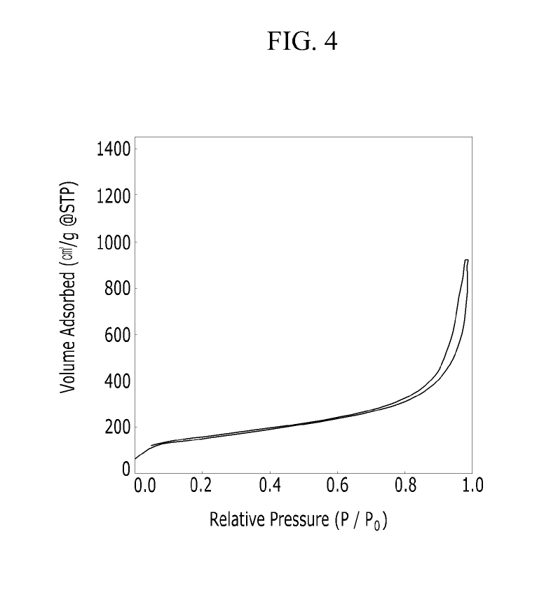

FIGS. 3 and 4 are graphs illustrating nitrogen adsorption-desorption isotherms of an exemplary embodiment of an aerogel composite according to Examples 1 and 3, respectively. Specifically, FIGS. 3 and 4 illustrate the volume of nitrogen absorbed in cubic centimeters per gram of aerogel composite at standard temperature and pressure versus the relative pressure; the actual pressure divided by atmospheric pressure in pascals.

Referring to FIGS. 3 and 4, the nitrogen (“N₂”) adsorption-desorption amount of the aerogel composite according to Examples 1 and 3 is changed depending on pressure, accordingly preparing an aerogel composition having fine pores.

Evaluation 2

The aerogel composites according to Examples 1 to 4 and Comparative Examples 1 to 3 are evaluated regarding line shrinkage ratio, compression strength, thermal conductivity, and density. The line shrinkage ratio may be calculated referring to a side length ratio of the wet gel before and after drying against the side length of the aerogel. The compression strength is measured by a universal testing machine (ASTM D695, manufactured by WITHLAB). The thermal conductivity is measured by a heat flow meter (HFM 436, manufactured by Netzsch). The density is calculated referring to the ratio of the bulk weight and the bulk volume.

The results are shown in Table 1.

TABLE 1

| | Line | | Thermal | |
|---|---|---|---|---|
| | shrinkage | Compression | conductivity | Density |
| | ratio (%) | Strength (MPa)^{*1} | (W/mK) | (g/cm³) |
| Example 1 | 14.3 | 0.23 | 18 | 0.13 |
| Example 2 | 5.0 | —^{*2} | 17.0 | 0.13 |
| Example 3 | 8.0 | 0.23 | 18.3 | 0.12 |
| Example 4 | 8.8 | 0.22 | 18.2 | 0.14 |
| Comparative | 23.2 | 0.05 | 17.5 | 0.13 |
| Example 1 | | | | |
| Comparative | 22.3 | 0.18 | 20.5 | 0.11 |
| Example 2 | | | | |

^{*1}compression strength at 10% deformation
^{*2}Not measured

Referring to Table 1, the aerogel composites according to Examples 1 to 4 have similar density and thermal conductivity with the aerogel composites according to Comparative Examples 1 and 2; however, they have improved line shrinkage ratio and compression strength.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An aerogel composite comprising
a support comprising a melamine-formaldehyde copolymer, wherein the support comprises a plurality of micro-openings, and
an aerogel matrix disposed in the micro-openings.

2. The aerogel composite of claim 1, wherein the aerogel matrix comprises an acrylamide-based compound, a benzoxazine-based compound, a bismaleimide-based compound, an aryl alcohol-based compound, a cellulose-based compound, a hydroxyl substituted benzene-aldehyde compound, silica, or a combination thereof.

3. The aerogel composite of claim 2, wherein the acrylamide-based compound is at least one of the compounds represented by the following Chemical Formulae 1 to 5: 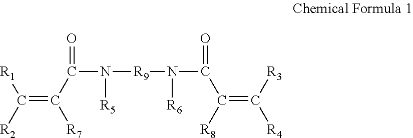
wherein, in Chemical Formula 1, R₁ to R₈ are each independently hydrogen, a substituted or unsubstituted C1 to C30 alkyl group, a substituted or unsubstituted C3 to C30 cycloalkyl group, a substituted or unsubstituted C6 to C30 aryl group, a substituted or unsubstituted C7 to C30 arylalkyl group, a substituted or unsubstituted C1 to C30 heteroalkyl group, a substituted or unsubstituted C2 to C30 heterocycloalkyl group, a substituted or unsubstituted C2 to C30 alkenyl group, a substituted or unsubstituted C1 to C10 alkoxy group, a substituted or unsubstituted C2 to C30 carbonyl group, a hydroxyl group, or a combination thereof, and R₉ is each independently a substituted or unsubstituted C1 to C30 alkylene group, a substituted or unsubstituted C3 to C30 cycloalkylene group, a substituted or unsubstituted C6 to C30 arylene group, a substituted or unsubstituted C7 to C30 arylalkylene group, a substituted or unsubstituted C13 to C30 arylenealkylenearylene, a substituted or unsubstituted C1 to C30 heteroalkylene group, a substituted or unsubstituted C2 to C30 heterocycloalkylene group, a substituted or unsubstituted C2 to C30 alkenylene group, or a combination thereof, 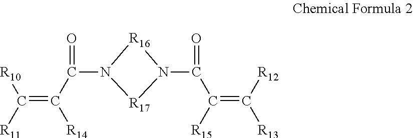
wherein, in Chemical Formula 2, R₁₀ to R₁₅ are independently hydrogen, a substituted or unsubstituted C1 to C30 alkyl group, a substituted or unsubstituted C3 to C30 cycloalkyl group, a substituted or unsubstituted C6 to C30 aryl group, a substituted or unsubstituted C7 to C30 arylalkyl group, a substituted or unsubstituted C1 to C30 heteroalkyl group, a substituted or unsubstituted C2 to C30 heterocycloalkyl group, a substituted or unsubstituted C2 to C30 alkenyl group, a substituted or unsubstituted C1 to C10 alkoxy group, a substituted or unsubstituted C2 to C30 carbonyl group, a hydroxyl group, or a combination thereof, and R₁₆ and R₁₇ are independently a substituted or unsubstituted C1 to C30 alkylene group, a substituted or unsubstituted C3 to C30 cycloalkylene group, a substituted or unsubstituted C6 to C30 arylene group, a substituted or unsubstituted C7 to C30 arylalkylene group, a substituted or unsubstituted C13 to C30 arylenealkylenearylene group, a substituted or unsubstituted C1 to C30 heteroalkylene group, a substituted or unsubstituted C2 to C30 heterocycloalkylene group, a substituted or unsubstituted C2 to C30 alkenylene group, or a combination thereof, 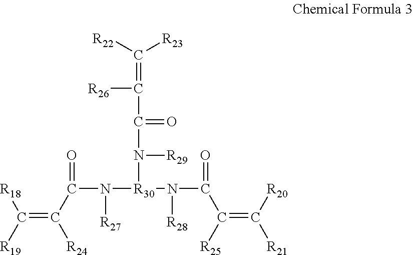
wherein, in Chemical Formula 3, R₁₈ to R₂₉ are each independently hydrogen, a substituted or unsubstituted C1 to C30 alkyl group, a substituted or unsubstituted C3 to C30 cycloalkyl group, a substituted or unsubstituted C6 to C30 aryl group, a substituted or unsubstituted C7 to C30 arylalkyl group, a substituted or unsubstituted C1 to C30 heteroalkyl group, a substituted or unsubstituted C2 to C30 heterocycloalkyl group, a substituted or unsubstituted C2 to C30 alkenyl group, a substituted or unsubstituted alkoxy group, a substituted or unsubstituted carbonyl group, a hydroxyl group, or a combination thereof, and R₃₀ is a substituted or unsubstituted C1 to C30 alkylene group, a substituted or unsubstituted C3 to C30 cycloalkylene group, a substituted or unsubstituted C6 to C30 arylene group, a substituted or unsubstituted C7 to C30 arylalkylene group, a substituted or unsubstituted C1 to C30 heteroalkylene group, a substituted or unsubstituted C2 to C30 heterocycloalkylene group, a substituted or unsubstituted C2 to C30 alkenylene group, or a combination thereof, 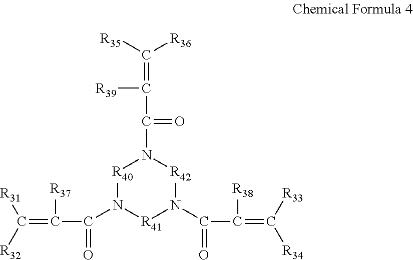
wherein, in Chemical Formula 4, R₃₁ to R₃₉ are each independently hydrogen, a substituted or unsubstituted C1 to C30 alkyl group, a substituted or unsubstituted C3 to C30 cycloalkyl group, a substituted or unsubstituted C6 to C30 aryl group, a substituted or unsubstituted C7 to C30 arylalkyl group, a substituted or unsubstituted C1 to C30 heteroalkyl group, a substituted or unsubstituted C2 to C30 heterocycloalkyl group, a substituted or unsubstituted C2 to C30 alkenyl group, a substituted or unsubstituted C1 to C10 alkoxy group, a substituted or unsubstituted C2 to C10 carbonyl group, a hydroxyl group, or a combination thereof, and R₄₀ to R₄₂ are each independently a substituted or unsubstituted C1 to C30 alkylene group, a substituted or unsubstituted C3 to C30 cycloalkylene group, a substituted or unsubstituted C6 to C30 arylene group, a substituted or unsubstituted C7 to C30 arylalkylene group, a substituted or unsubstituted C1 to C30 heteroalkylene group, a substituted or unsubstituted C2 to C30 heterocycloalkylene group, a substituted or unsubstituted C2 to C30 alkenylene group, oxygen, sulfur, or a combination thereof, and 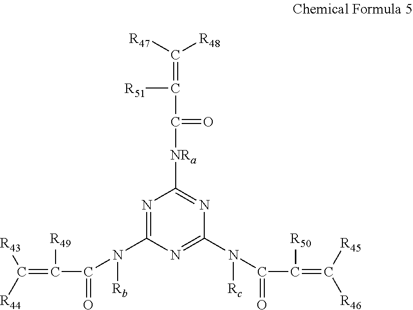
wherein, in Chemical Formula 5, R₄₃ to R₅₁ and Ra to Rc are each independently hydrogen, a substituted or unsubstituted C1 to C30 alkyl group, a substituted or unsubstituted C3 to C30 cycloalkyl group, a substituted or unsubstituted C6 to C30 aryl group, a substituted or unsubstituted C7 to C30 arylalkyl group, a substituted or unsubstituted C1 to C30 heteroalkyl group, a substituted or unsubstituted C2 to C30 heterocycloalkyl group, a substituted or unsubstituted C2 to C30 alkenyl group, a substituted or unsubstituted alkoxy group, a substituted or unsubstituted carbonyl group, a hydroxyl group, or a combination thereof.

4. The aerogel composite of claim 3, wherein the acrylamide-based compound is methylenebisacrylamide, N,N′-hexamethylenebisacrylamide, N,N′-(p-phenylene)bisacrylamide, 4,4′-methylenebis(phenylacrylamide), N,N′-(methylenebis-1,4-phenylene)bis(2-propeneamide), N,N′-(1,4-phenylene)bis(2-methacrylamide), 1,4-bis(acryloyl)piperazine, 1,3,5-triacryloylhexahydro-1,3,5-triazine, or a combination thereof.

5. The aerogel composite of claim 2, wherein the benzoxazine-based compound comprises a polymerization product of an aryl alcohol compound comprising at least two hydroxyl groups represented by the following Chemical Formula 6 and an amine compound comprising at least two amine groups represented by the following Chemical Formula 7:
[(HO)ₚ—(CRR′)]ᵣ—(Ar₁)-[L₁-[(Ar₂)—(OH)_{q}]ₙ]ₖ₁ Chemical Formula 6
wherein, in Chemical Formula 6, Ar₁ and Ar₂ are each independently a substituted or unsubstituted C6 to C30 aryl group, a substituted or unsubstituted C3 to C30 heteroaryl group, or a substituted or unsubstituted C7 to C30 alkylarylene group, provided that at least one unsubstituted ring carbon is present at the alpha position with respect to a hydroxyl group attached to Ar₂,
L₁ is a single bond, O, C(═O), S, SO₂, a substituted or unsubstituted C1 to C30 alkylene group, a substituted or unsubstituted C3 to C30 cycloalkylene group, a substituted or unsubstituted C6 to C30 arylene group, a substituted or unsubstituted C7 to C30 alkylarylene group, a substituted or unsubstituted C1 to C30 heteroalkylene group, a substituted or unsubstituted C2 to C30 heterocycloalkylene group, a substituted or unsubstituted C2 to C30 alkenylene group, or a combination thereof,
R and R′ are each independently hydrogen or a substituted or unsubstituted C1 to C10 alkyl group,
r and n are each independently an integer ranging from 0 to 4,
p and q are independently integers ranging from 1 to 4, and p+q is 3 or more, and
k1 is an integer ranging from 0 to 4, wherein r+k₁ is 1 to 6, and is determined by the valence of Ar₁,
[(NH₂)ₚ—(CRR′)ᵣ₁]ₘZ₁-[L₂-[(Z₂)—[(CR″R′″)ᵣ₂—(NH₂)_{q}]ₙ]ₖ₂ Chemical Formula 7
wherein, in Chemical Formula 7, Z₁ and Z₂ are each independently a substituted or unsubstituted C6 to C30 arylene group, a substituted or unsubstituted C3 to C30 heteroarylene group, a substituted or unsubstituted C7 to C30 alkylarylene group, or NR (wherein R is hydrogen, an unsubstituted C1 to C20 alkyl group, a C1 to C20 alkyl group substituted with an amino group, an unsubstituted C6 to C30 aryl group, or a C6 to C30 aryl group substituted with an amino group), or a combination thereof,
L₂ is a single bond, O, O(═O), S, SO₂, a substituted or unsubstituted C1 to C30 alkylene group, a substituted or unsubstituted C3 to C30 cycloalkylene group, a substituted or unsubstituted C6 to C30 arylene group, a substituted or unsubstituted C7 to C30 alkylarylene group, a substituted or unsubstituted C1 to C30 heteroalkylene group, a substituted or unsubstituted C2 to C30 heterocycloalkylene group, a substituted or unsubstituted C2 to C30 alkenylene group, or a combination thereof,
n and m are each independently an integer ranging from 1 to 5,
p and q are each independently an integer ranging from 1 to 4, provided that when k₂ is zero p is at least 2,
R, R′, R″, and R′″ are each independently hydrogen, a C1 to C10 alkyl group, or a combination thereof,
r1 and r2 are each independently an integer ranging from 0 to 4, and
k2 is an integer ranging from 0 to 4, wherein m+k₂ is selected according to a valence of Z₁.

6. The aerogel composite of claim 2, wherein the bismaleimide-based compound is represented by the following Chemical Formula 8: 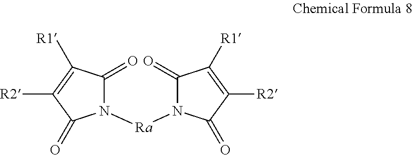
wherein, in Chemical Formula 8, R1′ and R2′ are each independently hydrogen or a substituted or unsubstituted C1 to C30 alkyl group, and Ra is a substituted or unsubstituted C3 to C30 cycloalkylene group, a substituted or unsubstituted C6 to C30 arylene group, a substituted or unsubstituted C13 to C30 arylenealkylenearylene group, a substituted or unsubstituted C27 to C90 (arylenealkylenearylene)ₙ group wherein n is an integer from 2 to 4, a substituted or unsubstituted C3 to C30 heterocycloalkylene group, a substituted or unsubstituted C5 to C30 heteroarylene group, a substituted or unsubstituted C12 to C30 arylene(heteroalkylene)arylene group, or a substituted or unsubstituted C26 to C90 (arylene(heteroalkylene)arylene)ₙ group wherein n is an integer from 2 to or a combination thereof.

7. The aerogel composite of claim 2, wherein the aryl alcohol-based compound is a polymerization product of a compound represented by the following Chemical Formula 9:
[(HO)ₚ—(Ar₁)]ₘ-L-[(Ar₂)—(OH)_{q}]ₙ Chemical Formula 9
wherein, in Chemical Formula 9,
Ar₁ and Ar₂ are each independently a substituted or unsubstituted C6 to C30 aryl group, a substituted or unsubstituted C3 to C30 heteroaryl group, a substituted or unsubstituted C7 to C30 alkylaryl group, or a combination thereof,
L is a single bond, O, O(═O), S, SO₂, P(═O), P(RR′R″) (wherein R, R′, and R″ are each independently hydrogen, a C1 to C10 alkyl group, or a C6 to C20 aryl group), a substituted or unsubstituted C1 to C30 alkylene group, a substituted or unsubstituted C3 to C30 cycloalkylene group, a substituted or unsubstituted C6 to C30 arylene group, a substituted or unsubstituted C7 to C30 arylalkylene group, a substituted or unsubstituted C1 to C30 heteroalkylene group, a substituted or unsubstituted C2 to C30 heterocycloalkylene group, a substituted or unsubstituted C2 to C30 alkenylene group, or a combination thereof,
n and m are each independently an integer ranging from 1 to 5, wherein n+m is determined according to a valance of L, and
p and q are independently integers ranging from 1 to 4.

8. The aerogel composite of claim 2, wherein the cellulose-based compound comprises a crosslinked product of a substituted or unsubstituted alkyl cellulose derivative represented by the following Chemical Formula 10 and a substituted or unsubstituted alkylene diphenylene diisocyanate compound represented by the following Chemical Formula 11: 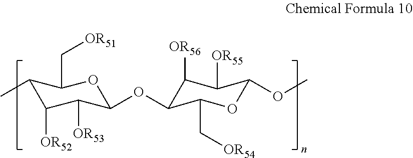
wherein, in Chemical Formula 10, R₅₁ to R₅₆ are each independently hydrogen or a C1 to C10 alkyl group, provided that at least one of R₅₁ to R₅₆ is a C1 to C10 alkyl group, and n is from 10 to 1000, 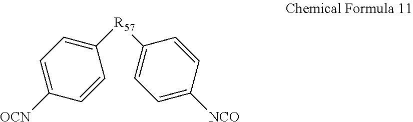
wherein, in Chemical Formula 11, R₅₇ is a C1 to C20 alkylene group.

9. The aerogel composite of claim 2, wherein the aerogel matrix comprises a resorcinol-formaldehyde copolymer a resorcinol formaldehyde-bisphenol A copolymer, or a combination thereof.

10. The aerogel composite of claim 1, wherein the plurality of the micro-openings each has an average largest diameter of less than about 300 micrometer.

11. The aerogel composite of claim 1, wherein the support has a two-dimensional honeycomb structure, a three-dimensional mesh structure, or a combination of structures comprising at least one of the foregoing.

12. The aerogel composite of claim 1, wherein the support has an expansion ratio or a shrinkage ratio of about 5% or less when contacting a solvent.

13. The aerogel composite of claim 1, wherein the aerogel composite has a density of about 0.015 g/cm³ or less.

14. The aerogel composite of claim 1, wherein the aerogel composite has porosity of about 90% or more.

15. The aerogel composite of claim 1, wherein the aerogel matrix comprises a plurality of pores having a size of about 2 nm to about 50 nm.

16. A manufacturing method for an aerogel composite, comprising:
providing a support comprising a melamine-formaldehyde copolymer, wherein the support comprises a plurality of micro-openings;
disposing a composition for producing an aerogel matrix in the support; and
forming the aerogel matrix from the composition disposed in the support to provide the aerogel composite.

17. The manufacturing method of claim 16, wherein the filling of an aerogel solution for producing an aerogel matrix into the support comprises:
preparing an aerogel solution, wherein the aerogel solution comprises a solvent and an acrylamide-based compound, a benzoxazine-based compound, a bismaleimide-based compound, an aryl alcohol-based compound, a cellulose-based compound, a resorcinol formaldehyde-based compound, a resorcinol formaldehyde bisphenol-based compound, a silica compound or precursors thereof, or combinations thereof;
disposing the aerogel solution into the micro-openings of the support; and
gelating the filled aerogel solution.

18. The manufacturing method of claim 16, wherein the solvent is removed by atmospheric pressure drying, supercritical drying, or a combination thereof.
